(19) United States
(12) Patent Application Publication
(10) Pub. No.: US 2007/0063042 A1
(43) Pub. Date: Mar. 22, 2007

(54) Optical reading system

(76) Inventors: Li-Hung Lai, Taichuang (TW); Wen-Sheng Hsieh, Taichuang (TW)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/228,303

(22) Filed: Sep. 19, 2005

(51) Int. Cl. G06K 7/10; G06K 19/06

(52) U.S. Cl. 235/454; 235/468; 235/491

(57) ABSTRACT

The invention relates to an optical reading system. The optical reading system comprises: an object, a sensor assembly and a processing device. The object has at least one predetermined pattern on a surface of the object. The predetermined pattern is printed in a predetermined ink for receiving light beams from a surrounding light source and for generating corresponding infrared ray. The sensor assembly is used for receiving the corresponding infrared ray from the ink of the predetermined pattern and for capturing the information of the predetermined pattern. According to the invention, the optical reading system of the invention only utilizes the outside light source, and does not need the internal light source as described in the prior art. Therefore, the optical reading system of the invention can save power and reduce the required elements.

### BACKGROUND OF THE INVENTION

1. Field of the Invention

The present invention relates to an optical reading system, more particularly, an optical reading system without internal light source, and detect the surrounding light whether enough to read book.

2. Description of the Related Art

Referring to FIG. 1, the conventional optical reading system 10 has been disclosed in US 2003/0133164 A1. The optical reading system 10 comprises: a sensor assembly 11, an image-processing circuit 12, an output circuit 13 and an object 14. The sensor assembly 11 comprises: an internal light source 111, a filter 114, a lens 115 and an image sensor 116. The internal light source 111 is used to emit infrared ray 112 to a pattern 141 on a surface of the object 14.

The pattern 141 is printed in the conventional ink with a black layer can reflect the infrared ray 113 to the lens 114, and the filter 115. The image sensor 116 receives the infrared ray through the lens 114 and the filter 115 and converts the image of the pattern 141 into electronic information.

The image-processing circuit 12 receives the electronic information from the image sensor 116. The image-processing circuit 12 comprises a digital signal processor 121 and an ROM card 122. The digital signal processor 121 executes the image process. The ROM card 122 stores the mapping relationship of the electronic information and output signals. The output circuit 13 is a speaker for receiving output signal from the image-processing circuit 12 and outputting audio information corresponding to the pattern 141.

For example, the pattern 141 is a shape of an apple. The image sensor 116 receives the infrared ray reflected by the pattern 141 and the infrared ray is converted to the electronic information representing the shape of the pattern 141. The image-processing circuit 12 can recognize the electronic information, then the output circuit 13 will output “apple” audio information. Therefore, the optical reading system 10 can be used in a typical language-learning book or children-teaching book.

The conventional optical reading system 10 must utilize the internal Infrared light source 111 to emit an active light beam, and a cover 117 is needed to shield the outside light beam so as to prevent the interference of the outside light beam. Therefore, the conventional optical reading system 10 need more power for providing the internal light source 111 and more required elements.

Therefore, it is necessary to provide an optical reading system so as to solve the above problem.

### SUMMARY OF THE INVENTION

One objective of the present invention is to provide an optical reading system. The optical reading system comprises: an object, a sensor assembly and a processing device. The object has at least one predetermined pattern on a surface of the object. The predetermined pattern is printed in a predetermined ink for receiving light beams from a surrounding light source and for generating corresponding infrared ray. The sensor assembly is used for receiving the corresponding infrared ray from the ink of the predetermined pattern and for capturing the information of the predetermined pattern. The processing device is used for outputting a corresponding signal according to the information of the predetermined pattern.

According to the invention, the optical reading system of the invention only utilizes the outside light source, and does not need the internal light source as described in the prior art. Therefore, the optical reading system of the invention can save power and reduce the required elements. Besides, the optical reading system also can detect the surrounding light, and determine whether the brightness of the light source is enough or not, and outputs a warning signal by the alarm when the brightness of the light source is not enough. Therefore, the optical reading system can alarm people not reading book in the dark light condition.

### BRIEF DESCRIPTION OF THE DRAWINGS

FIG. 1 shows a conventional optical reading system.

FIG. 2 shows an optical reading system, according to the invention.

### DETAILED DESCRIPTION OF THE INVENTION

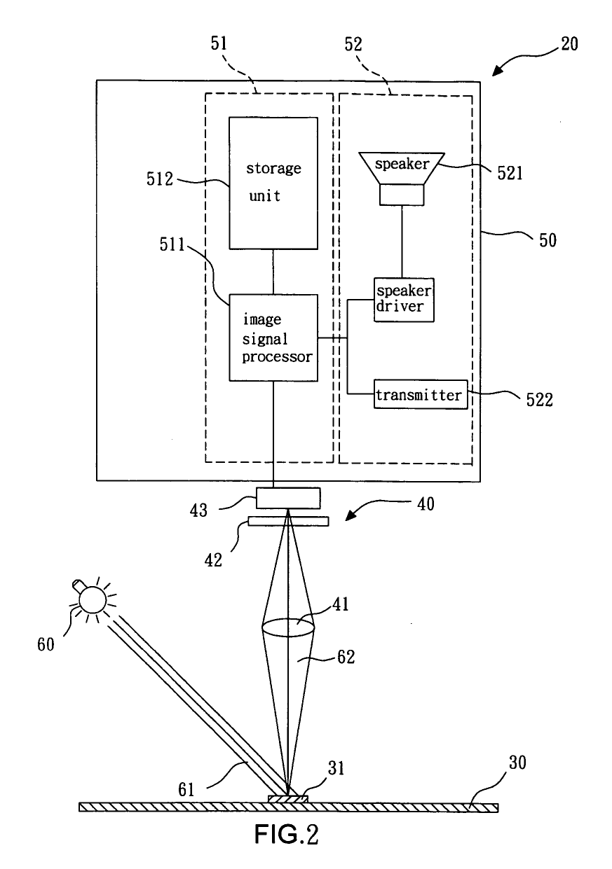

Referring to FIG. 2, according to the invention, an optical reading system 20 comprises: an object 30, a sensor assembly 40 and a processing device 50. The object 30 has at least one predetermined pattern 31 on a surface of the object 30. The predetermined pattern 31 is printed in a predetermined ink. The predetermined ink can receive light beams 61 from a light source 60 and then generate corresponding infrared ray 62. Furthermore, the predetermined ink can absorb any light and emit infrared ray. The light source 60 may be a normal fluorescent lamp or a desk lamp. The light source 60 emits visible light beams 61 to the predetermined pattern 31, and the predetermined pattern 31 with the predetermined ink can generate corresponding infrared ray 62.

The sensor assembly 40 comprises a lens 41, a filter 42 and a sensor 43. The lens 41 and the filter 42 are used for processing the corresponding infrared ray 62 and for transmitting the processed corresponding infrared ray to the sensor 43. The sensor 43 is used for receiving the processed corresponding infrared ray of the predetermined pattern 31 and for outputting the information of the predetermined pattern 31 to the processing device 50. The sensor 43 may be a CCD sensor or a CMOS sensor. In the embodiment of the invention, the sensor 43 can capturing the information of the predetermined pattern 31 by receiving the corresponding infrared ray of the predetermined pattern 31.

The processing device 50 is used for outputting a corresponding signal according to the information of the predetermined pattern 31. The processing device 50 comprises an image processing module 51 and an output module 52. The image processing module 51 has an image signal processor 511 and a storage unit 512. The image signal processor 511 is used for processing the information of the predetermined pattern 31 from the sensor 43. The storage unit 512 is used for storing the corresponding output signal. That is, the image signal processor 511 can recognize the information of the predetermined pattern 31 and obtain the corresponding output signal from the storage unit 512. Then, the corresponding output signal is transmitted to the output module 52.

The output module 52 may be a speaker 521 or a transmitter 522. The speaker 521 can receive the corresponding output signal from the image processing module 51 and output audio information corresponding to the pattern 31. The transmitter 522 can transmit the corresponding output signal to an external system, for example personal computer.

The information of the predetermined pattern 31 comprises the information of the brightness of the light source 60. Therefore, the optical reading system 20 can determine whether the brightness of the light source 60 is enough or not. When the brightness of the light source 60 is not enough, an alarm will output a warning signal. In the embodiment, the alarm is the speaker 521.

For example, the pattern 31 is a shape of an orange. The optical reading system 20 may be a pen type. The light source 60 emits visible light beams to the surface of the object 30, and all the patterns on the object 30 can receive the visible light beams from the light source 60, and all the patterns of the object 30 can generate corresponding infrared ray. The optical reading system 20 is moved to the position above the pattern 31 so as to capture the corresponding infrared ray from the pattern 31.

The sensor 43 receives the corresponding infrared ray generated by the pattern 31 and the corresponding infrared ray is converted to the electronic information representing the shape of the pattern 31. The image processing module 51 can recognize the electronic information, and output the corresponding output signal to the output module 52. The speaker 521 can speak “orange” audio information, or the transmitter 522 can transmit the corresponding output signal to the external system.

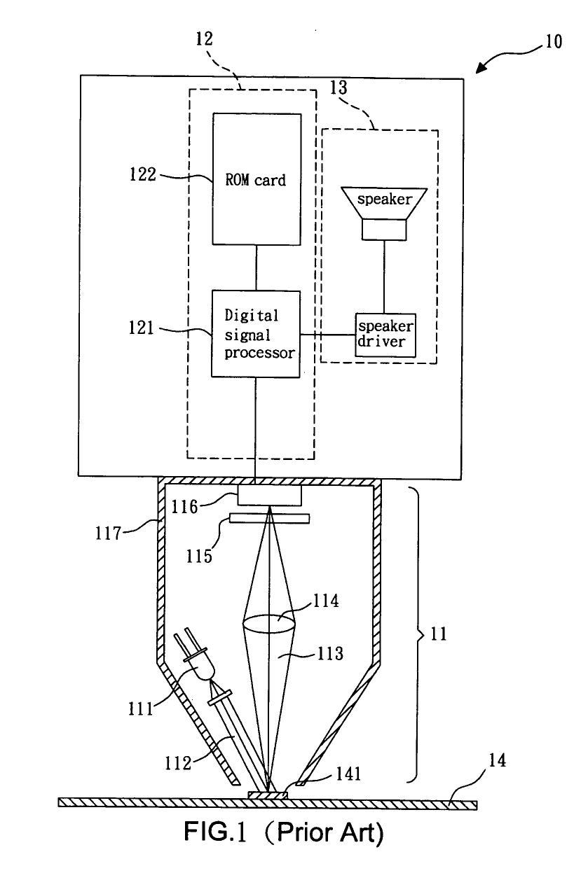

Accordingly, the optical reading system 20 can be used in a typical language-learning book, children-teaching book or the other optical electronic devices. Compared to the conventional optical reading system 10, the optical reading system 20 of the invention only utilizes the outside fluorescent lamp or desk lamp, and does not need the internal light source 111 as shown in FIG. 1. Therefore, the optical reading system 20 of the invention can save power and reduce the required elements.

Besides, the optical reading system 20 can determine whether the brightness of the light source 60 is enough or not, and outputs a warning signal by the speaker 521 when the brightness of the light source 60 is not enough. Therefore, the optical reading system 20 can alarm people not reading book in the dark light condition.

While an embodiment of the present invention has been illustrated and described, various modifications and improvements can be made by those skilled in the art. The embodiment of the present invention is therefore described in an illustrative, but not restrictive, sense. It is intended that the present invention may not be limited to the particular forms as illustrated, and that all modifications which maintain the spirit and scope of the present invention are within the scope as defined in the appended claims.

1. An optical reading system, comprising:
an object which includes at least one printed ink pattern on a surface of the object, wherein an ink of the printed ink pattern is responsive to incident light beams from a surrounding light source to emit corresponding infrared rays;
a sensor assembly which receives the corresponding infrared rays emitted from the ink of the printed ink pattern and which captures information illustrated by the printed ink pattern; and
a processing device which outputs an output signal according to the information illustrated by the printed ink pattern.

2. The optical reading system according to claim 1, wherein the sensor assembly comprises an infrared sensor which receives the corresponding infrared rays generated from the ink of the printed ink pattern and which outputs the information illustrated by the printed ink pattern to the processing device.

3. The optical reading system according to claim 2, wherein the sensor assembly further comprises a lens and an infrared filter which processes the corresponding infrared rays and transmits the processed corresponding infrared rays to the sensor.

4. The optical reading system according to claim 1, wherein the processing device further comprises an alarm which outputs a warning signal when the brightness of the surrounding light source is insufficient.

5. The optical reading system according to claim 1, wherein the processing device comprises:
an image processing module which includes an image signal processor which processes the information captured by the sensor module, and a storage unit which stores the information processed by the image signal processor; and
an output module which generates an output signal indicative of the information processed by the image signal processor.

6. The optical reading system according to claim 5, wherein the output module is a speaker.

7. The optical reading system according to claim 5, wherein the output module is a transmitter.

8. The optical reading system according to claim 1, wherein the ink further can absorb any light and emit infrared rays.
